(19) United States
(12) Patent Application Publication
(10) Pub. No.: US 2009/0244279 A1
(43) Pub. Date: Oct. 1, 2009

(54) Surveillance systems

(76) Inventor: Jeffrey Thomas Walsh, Houston, TX (US)

Correspondence Address: Guy L. McClung, III, 5315-B F.M., 1960 Road West, #114, Houston, TX, 77069-4410, US

(21) Appl. No.: 12/079,426

(22) Filed: Mar. 26, 2008

(51) Int. Cl. H04N 7/18

(52) U.S. Cl. 348/143; 348/E07.085

(57) ABSTRACT

Systems and methods are disclosed for surveillance including surveillance units which, in certain aspects, include a first unit for surveillance at a site, the first unit having a first base, a first local archiver, first surveillance apparatus on the base including at least one first surveillance component, the at least one first surveillance component for producing first surveillance signals, first transmitting apparatus for transmitting the first surveillance signals from the first surveillance component to the first local archiver, the local archiver including processing apparatus for processing the first surveillance signals to produce a first record of the surveilling of the site, and the local archiver including connection apparatus for making the first record available by remote access. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### BACKGROUND OF THE INVENTION

1. Field of the Invention

The present invention is directed to surveillance systems; to such systems with multiple surveillance units in remote locations; and, in certain particular aspects, to such systems with units spaced-apart by relatively large distances.

2. Description of Related Art

There are a variety of known surveillance systems, some stationary, some portable, which include one or more cameras (still and video); lights; sensors (motion; infrared; environmental, e.g. gas, temperature, humidity); motion detectors; power supplies; microphones; control systems; remote access systems; monitors; alarms; electronics equipment; and enclosures.

Known systems include supports and masts (single piece and telescoping) to which various items are connected. Certain known systems are mounted on a variety of vehicles, including trailers, cars, trucks, and tracked vehicles.

Problems and disadvantages of known systems include: with certain known systems it is difficult or impossible to communicate using satellite systems due to insufficient available bandwidth. Certain known systems do not provide mesh communications. Certain known systems use only discrete remote units that act as individual disparate systems with no unification or communication with a central system and with such known systems it is not possible to view multiple remote units from a single unified platform (a platform that allows a user to simultaneously view multiple remote nits at multiple remote locations using one piece of software on a single computer). with certain known units there is no local archiving at the unit which would conserve bandwidth; and with certain known units there is no system involving multiple units one of which has a local archiver which some of the units can share.

Industrial sites, including, but not limited to, oilfield locations, pipelines, and oil and gas drilling and production facilities are often in remote areas where access is difficult and power which is at a premium is often generated on-site. Monitoring such sites presents particular problems; e.g. in providing power generation and communications facilities on-site.

U.S. Pat. No. 4,709,265 discloses a remote control mobile surveillance system for hazardous environments and the like having a radio remote controlled vehicle that is sized and shaped for optimum maneuverability and stability, including mobility on stairs and inclined surfaces. The vehicle is designed to have a low center of gravity that is shiftable up and down, front to rear and side to side under operator control in order to provide stability. The top deck of the vehicle is uniquely shaped and is adapted to support any of several payloads, including an articulated arm module that is moveable in a pan and tilt direction and a smear sampler mechanism for repeatedly taking surface samples. The vehicle is moved by independently operated, motor driven tracks located on each of the two longitudinal sides of the vehicle and is adapted to move in a forward, reverse and rotational directions. Remote monitoring is provided by stereoptic TV cameras, stereo sound, and variety of environmental sensors. In one aspect, such a system has: an operator control center, the center having manual command operation and transmission means, telemetry receive and reporting means and antenna means; and a surveillance vehicle located remote from said control center and in wireless communication therewith; the vehicle having chassis means sized and shaped to fit within standard doorways and stairways and to provide an optimally low center of gravity for the vehicle; propulsion means adapted to provide movement to the vehicle and mounted on the chassis means and having at least two independently controllable motor and track means, cover means removably mounted on the chassis means and adapted to support a plurality of payloads, payload means adapted to be movable in at least one direction and to have mounted thereon an operative load means, the payload means being removably mounted on the cover means; communications means adapted to receive commands from and transmit telemetry to the operator control center, the means being operatively connected to the propulsion means and the payload means, whereby an operator at the operator control center can remotely control and monitor the movement of the vehicle and the operation of the payload means, the cover means being substantially rectangular in shape, having a vehicle front, a vehicle rear and two longitudinal side edges, a centrally located planar portion on which is mounted the payload means and a front planar apron portion extending from the payload at an angle downward to the vehicle front edge, and the payload means being adapted to move the operative load forward and below the centrally located planar position, along the planar apron position of the cover means, whereby the center of gravity of the vehicle may be moved lower and forward dynamically during movement of the vehicle up an inclined surface under remote control from the operator control center.

U.S. Pat. No. 4,815,757 discloses rapid development surveillance vehicles and methods which are for detecting illegal immigration across national borders and the like. An off-the-road vehicle is equipped with a rapid mast erection/retraction assembly which includes a carriage mechanism which carries a telescoping mast. A track mechanism slidably carries the carriage mechanism by means of a fixed support and pivoting support arms. Ram air cylinders move the carriage mechanism in translational and rotational movement as guided on the track mechanism in a manner that the mast is moved from a stowed horizontal position to an erect vertical position. During erection of mast, a longitudinal roof opening is opened by means of a main door and displacement door in an automatic manner. Once erect, a leveling system checks to ensure that the vehicle is within one degree of level. Both level sensors and pressure sensors ensure that the vehicle is level and that all four jack legs are firmly engaged against the ground prior to extension of mast. Once the vehicle is within the prescribed level conditions, mast is pneumatically extended to a height of thirty feet whereupon a detection device which may be in the form of an infrared camera is ready for surveillance. The camera is mounted on a pan/tilt device which rotates it in a horizontal plane and tilts it in a vertical plane for increased surveillance. With the mast within one degree of true vertical, a stable platform is provided for the camera so that a nondistorted image appears on the display of a monitor remote from the camera. In one aspect, a rapid deployment surveillance vehicle is disclosed from which a detection device may be rapidly deployed from a stowed concealed position within a vehicle to an elevated vertical position for surveilling a detected event having: a mast on which the detection device is carried; a rapid erection/retraction system carried within the vehicle for deployment of the mast and detection device from the stowed, concealed position to an initial erect vertical position; a mast extension system for extending the detection device vertically to the elevated position elevated from the initial erect position considerably above the vehicle; a leveling system for leveling the vehicle during the time that the detection device is extended to the elevated position which includes: jack means carried adjacent each corner of the vehicle for engaging the ground and raising the vehicle, drive means for actuating the jack means, level sensor means for sensing a level condition of the vehicle and generating a level signal representative of the level condition, and control means for controlling the mast extension system and the leveling system in conjunction with each other, the control means controlling the drive means in response to the level sensor signal for simultaneously controlling the jack means and leveling the corners and the vehicle continuously while the detection device is extended to the elevated position, and the level sensor means continuously sensing the level condition for generating the level sensor signal while surveilling the detected event, platform mounting means for mounting the detection device to a free end of the mast; and the control means of the leveling system controlling the jack drive to level the vehicle continuously during surveillance for maintaining the extended mast within a prescribed range of true vertical so that the detection device is stably carried by the mast in the elevated position providing a stable, enhanced image of the detected event on the display of a monitor continuously while surveilling the detected event.

U.S. Pat. No. 7,267,496 discloses temporary surveillance systems that include a platform having a plurality and variety of cameras or sensors mounted thereto, and a base enclosure adapted to accommodate a power supply, a variety of electronics and other equipment for controlling and providing power to the surveillance equipment. The base is constructed to be tamper resistant and immovable by manual means. A substantially hollow support pole includes a lower portion detachably mounted to the base, and an upper portion mounted to the platform. Wires and cables for connecting the surveillance equipment with the electronics and power supply are run through the support pole. Power to the system may be supplied through existing power sources, for example a 120V power source. In certain aspects, the system is an unmanned portable surveillance system having: a base configured for placement on the ground and the base being configured to support the surveillance system in an upright freestanding position and having a weight sufficient to substantially prevent movement thereof by hand; at least one camera positioned above the base at a height sufficient to put it substantially out of reach of a person who may want to tamper with said at least one camera, the at least one camera configured to obtain visual images of objects in the vicinity of the base; and a recorder positioned in a secure location configured to prevent unauthorized access to the recorder, the recorder being configured to record the visual images obtained by the at least one camera without human intervention during ongoing surveillance; wherein the base, the camera, and the recorder are configured to be readily transportable to a location for surveillance of an area in the vicinity of the system, and wherein the portable surveillance system further has a circuit breaker. In one aspect, the system is an unmanned portable surveillance system, the system having: a base configured for placement on the ground and the base having a weight sufficient to substantially prevent movement thereof by hand; at least one camera positioned above the base at a height sufficient to put it substantially out of reach of a person who may want to tamper with said at least one camera, the at least one camera configured to obtain visual images of objects in the vicinity of the base; and a recorder positioned in a secure location within the that is configured to prevent unauthorized access, the recorder being configured to record the visual images obtained by the at least one camera without human intervention during ongoing surveillance; wherein the base, the camera, and the recorder are configured to be readily transportable to a location for surveillance of an area in the vicinity of the system, wherein the portable surveillance system further has a ground fault breaker.

The present inventors have recognized the need for efficient and effective portable surveillance systems; and for such systems with multiple remote units which can communicate effectively with each other, with a central location, and with a client in another location.

### BRIEF SUMMARY OF THE INVENTION

The present invention discloses, in certain aspects, surveillance systems which are portable and which include multiple surveillance units in a network with a host system; connection to a client; communication via multiple modes such as satellite, radio, wireless, internet, and/or land lines; and real time access to signals from each unit.

In certain aspects, such systems have units each with its own power supply, including, but not limited to, on-site generators (e.g. diesel-powered or solar-powered generators), batteries, and solar power apparatuses.

In certain aspects, such systems provide on-site and remote real time access to various items and equipment on each surveillance unit.

In certain aspects, such systems provide inter-communication from one unit to another so that a unit that is most remote from a central location can communicate, via intermediately spaced units, with the central location.

The present invention discloses, in certain aspects, methods for surveilling a site, the methods including: locating a first unit for surveillance at a site, the first unit including a first base, a first local archiver (e.g., with a control system, e.g., including a computer), first surveillance apparatus on the base for surveilling the site with at least one first surveillance component; producing first surveillance signals with the first surveillance component; transmitting the first surveillance signals from the first surveillance component to the first local archiver; processing the first surveillance signals in the local archiver to produce a first record of the surveilling of the site; and making the first record available by remote access, in real time and/or for review historically. In one aspect, such methods include making the record available via a central server in communication with the first local archiver and with a remote viewing site.

In certain aspects, such methods include: locating a second unit for surveillance spaced-apart from the first unit, each of the first unit and the second unit having a mesh radio system; the second unit including a second base, a second surveillance apparatus for surveilling an area adjacent the second unit and including at least one second surveillance component, the second surveillance component for producing second surveillance signals; transmitting the second surveillance signals from the second unit to the first unit via the mesh radio systems; processing the second surveillance signals from the second surveillance apparatus in the first local archiver to produce a second record of the surveillance of the area adjacent the second unit; and making the second record available by remote access.

In certain aspects, the present invention discloses systems for surveilling a site, the systems including: a first unit for surveillance at a site, the first unit including a first base, a first local archiver, first surveillance apparatus on the base including at least one first surveillance component, the at least one first surveillance component for producing first surveillance signals, first transmitting apparatus for transmitting the first surveillance signals from the first surveillance component to the first local archiver, the local archiver processing apparatus for processing the first surveillance signals to produce a first record of the surveilling of the site, and the local archiver including connection apparatus for making the first record available by remote access.

Such systems may have, in certain aspects, a second unit for surveillance spaced-apart from the first unit; each of the first unit and the second unit having a mesh radio system; the second unit including a second base, a second surveillance apparatus for surveilling an area adjacent the second unit and including at least one second surveillance component; the second surveillance component for producing second surveillance signals; second transmitting apparatus for transmitting the second surveillance signals from the second unit to the first unit via the mesh radio systems; the first local archiver including processing apparatus for processing the second surveillance signals from the second surveillance apparatus in the first local archiver to produce a second record of the surveillance of the area adjacent the second unit; and the local archiver connection apparatus also for making the second record available by remote access.

Accordingly, the present invention includes features and advantages which are believed to enable it to advance portable surveillance system technology. Characteristics and advantages of the present invention described above and additional features and benefits will be readily apparent to those skilled in the art upon consideration of the following detailed description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide the embodiments and aspects listed above and:

New, useful, unique, efficient, non-obvious systems and methods for surveillance, particularly for remote site surveillance;

Such systems and methods which include multiple units in communication with a central control;

Such systems and methods with a unit with an accessible local archiver;

Such systems and methods in which multiple units share a local archiver; and

Such systems and methods which provide real time access to the operator of the system and to a client using the system.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later attempt to disguise it by variations in form or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention or of the claims in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIG. 1A is a side view of a surveillance unit according to the present invention.

FIG. 1B is an end view of the surveillance unit of FIG. 1A.

FIG. 2A is a side view of a surveillance unit according to the present invention.

FIG. 2B is an end view of the surveillance unit of FIG. 2A.

FIG. 3 is a schematic view of a block diagram of for a surveillance unit according to the present invention.

FIG. 4 is a schematic view of a block diagram for a surveillance unit according to the present invention.

FIG. 5 is a schematic diagram of an electronics system for a surveillance unit according to the present invention.

FIG. 6 is a schematic view of a surveillance system according to the present invention.

Presently preferred embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DETAILED DESCRIPTION OF THE INVENTION

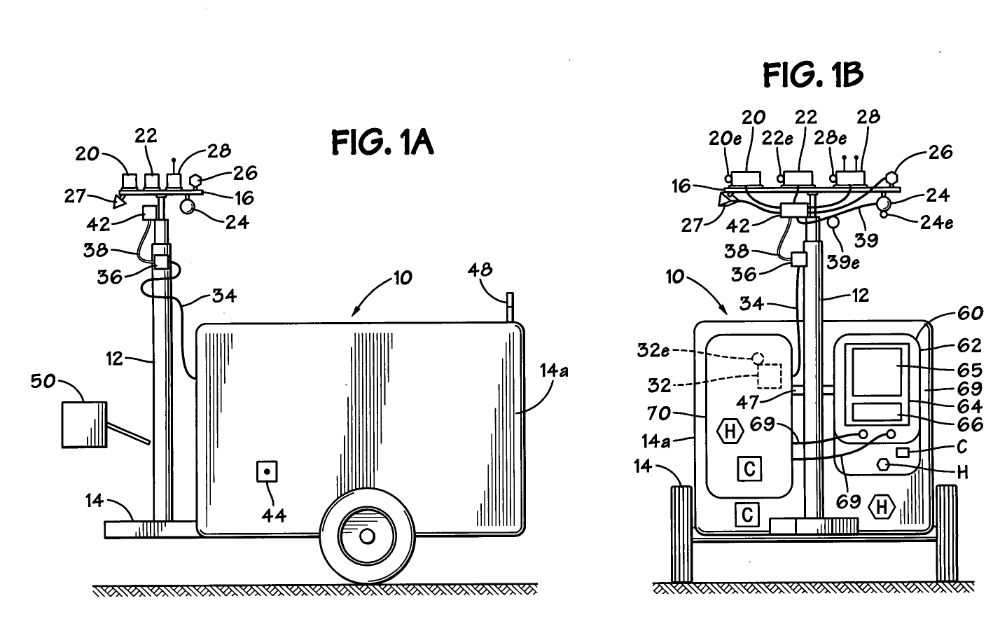

FIGS. 1A and 1B show a surveillance unit 10 according to the present invention which has a telescoping mast 12 mounted on a vehicle, e.g. on a wheeled trailer 14 with an enclosure 14a. Of course it is within the scope of the present invention to mount the surveillance unit 10 on any base, e.g., a truck, car, mobile robots, skid, portable building or tracked vehicle. In certain aspects the mast 12 telescopes up to a height of about thirty feet.

A platform 16 on the mast 12 includes a fixed camera 20 (still or video); a motion detector 22; a PTZ (pan, tilt, zoom) camera 24 (still or video); sensor(s) 26; light(s) 27; and a radio system 28 (which can serve as a mesh radio system for communication with other units and/or other local archivers). Such a mesh radio system provides a network in which there are at least two paths to each unit (or each “node”) and each unit can communicate through one or more intermediate units to reach any destination or location on the network and such communication is possible even when there is, for example, no direct path between two units or two nodes. Any known sensor or sensors may be used including but not limited to, sensors for motion, infrared, intrusion, biological agents, chemical agents, and/or gas. The mast is held by a holder 48 when in a folded down position.

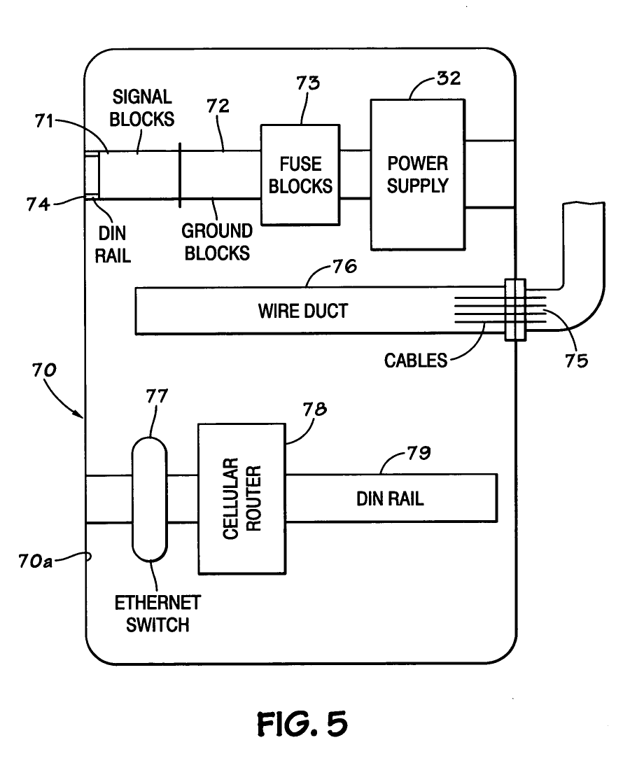

Power for the various items of equipment is provided from a power supply 32 (see FIG. 5) which can, according to the present invention, be mounted at any appropriate location on the trailer 14. Power is transmitted from the power supply 32 in a power lines 34 to a first junction box 36 and from there in flexible power lines to a second junction box 42 from which individual power lines and/or communication cables 39 extend in a flexible conduit 38 to each piece of equipment on the platform 16.

In one aspect, the power supply 32 is an AC power supply. The trailer 12 includes an AC power input 44 for inputting AC power from an external AC power supply.

Optionally, a separate generator system 50 provides power to the surveillance unit 10. Such a system 50 may be diesel powered, solar powered, and/or battery powered.

The surveillance unit 10 includes a local archiver system 60 within an enclosure 62. The local archiver system 60 includes a control system 64 with a computer apparatus 65 (e.g. PLC, laptop computer, computer, etc.) with an optional system power supply 66 (e.g. any suitable power supply including, but not limited to, a battery apparatus and/or a solar power supplier) and connections 69 for connecting the system 62 to items on an electronics module 70 in a housing 70a. The local archiver system 60 receives data from all the systems components, cameras (still, video, PTZ), sensors, and detectors; records and processes the data; and makes it available for transmission from the surveillance unit.

The control system 64 is in communication with each item on the platform 16, with devices as described below in the electronics module 70, and with each meter, instrument, gauge, sensor and detector. The control system 64 controls each of the items on the platform; receives signals from the local archiver and from each meter etc. and from each item on the platform continuously in real time; records all such signals, including streaming video from cameras; and transmits data corresponding to all the signals to the electronics module. The local archiver system is optional for any unit according to the present invention.

As shown in FIG. 5, the electronics module 70 includes the power supply 32 and: signal blocks 71 which receives signals from each component; ground blocks 72 for grounding all components; fuse blocks 73 which provide a fuse function for all components; a DIN rail 74 providing mounting for the blocks and the power supply 32; cables 75 connecting all components for power and signalling; a wire duct 76 around the cables 75; an ethernet switch 77 providing communication between components; a cellular router 78 providing connection between the system 60 and its components and an external network; and a DIN rail 79 that provides mounting for the switch 77 and the router 78. The cables 75 are connected to the control system 62 via an internal conduit 47.

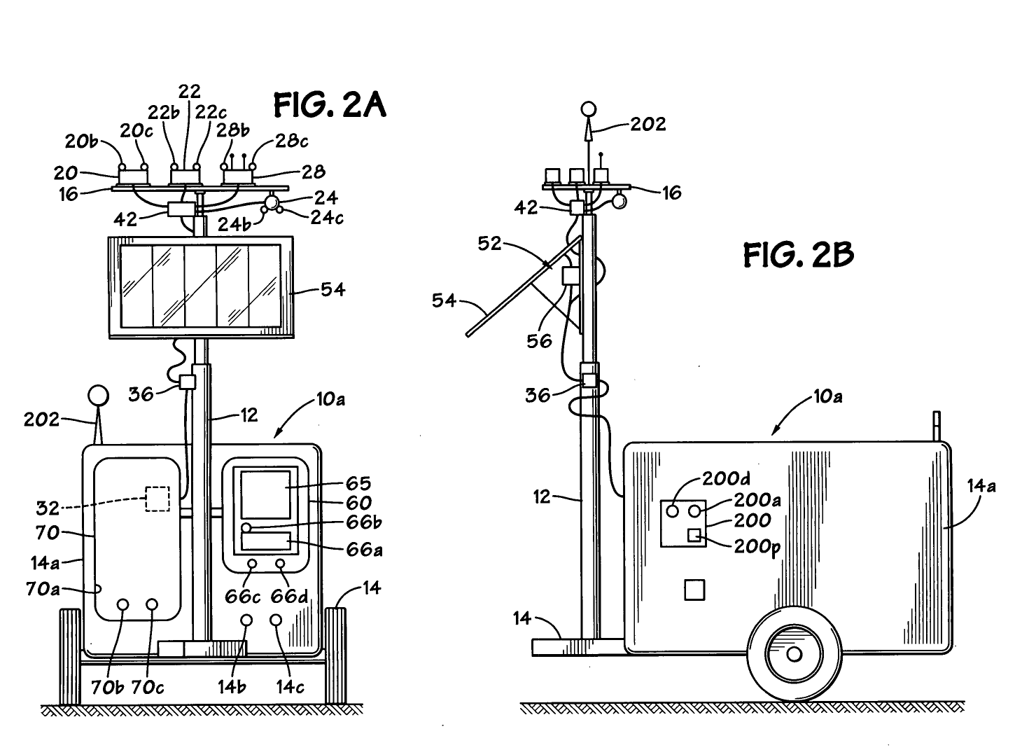

FIGS. 2A and 2B illustrate a surveillance unit 10a, like the surveillance unit 10 (and like numerals indicate like parts); but with a solar power system 52 for providing power to the surveillance unit 10. The system 52 has a solar array 54 and a solar power processor/control 56 connected to and/or within the module 70 for sending power to the line 38.

Any system according to the present invention may have a variety of sensors, meters, instruments, gauges, and detectors for monitoring the status of components of the system. As shown in FIG. 2A, the power and supply 66a (like the power supply 66, FIG. 1B) is a battery and a meter 66b monitors the voltage level of the battery and the meter 66b is in communication with the local archiver 60. A temperature sensor 66c senses temperature within the enclosure 62 and a humidity sensor 66d senses humidity within the enclosure 62. Both sensors 66c and 66d are in communication with the local archiver 60.

FIG. 2A illustrates that the trailer enclosure 14a of any system according to the present invention may include a temperature sensor 14b and a humidity sensor 14c; and that an electronics module in a system according to the present invention, like the electronics module 70, may have within its enclosure (like the enclosure 70a) a temperature sensor 70b and a humidity sensor 70c. All these sensors are in communication with the control system 64. Similar sensors 20b, 20c; 22b, 22c; 28b, 28c; and 24b, 24c are provided for the items 20, 22, 24, and 28 and all such sensors are in communication with the control system 64.

Any electrical apparatus or line in a system according to the present invention may have meter(s), gauge(s), and/or sensor(s) for sensing the electrical characteristics and levels (e.g. voltage and/or amperage) of such apparatus or line. For example, as shown in FIG. 1B, electrical meters 20e, 22e, 24e, 28e, 32e, and 39e indicate power level, voltage and/or amperage for their respective item or line and are all in communication with the control system 64.

As shown in FIG. 2B, any system according to the present invention may include a device monitoring system 200 as part of a control system (like the control system 64) or as a separate apparatus which has inputs for receiving signals from each meter, sensor etc. and outputs in communication with a control system and/or in communication with a central server. The appropriate digital 200d and analog inputs 200a and outputs are provided for each meter, sensor, etc. and, optionally, a network port 200p for communication.

The system 200, either directly or via the control system 64, can provide alerts, alarms, and messages (e.g. email) via the status of any item or component of a unit according to the present invention. At a central location (e.g. at the location of a central server) and/or at a remote location (e.g. at a remote location of a system operator and/or at a remote client location) all meters, sensors, etc. can be monitored in real time and/or historically and all alerts, alarms, and messages can be provided on-site and/or to remote locations. For example at a remote operator site and/or at a remote client site an operator and/or a client can query any meter, sensor, etc. in real time and can view (screen, chart, video, audio, via a web page, via a network management system, e.g. using SNMP, simple network management protocol) the historical record and/or real time transmissions.

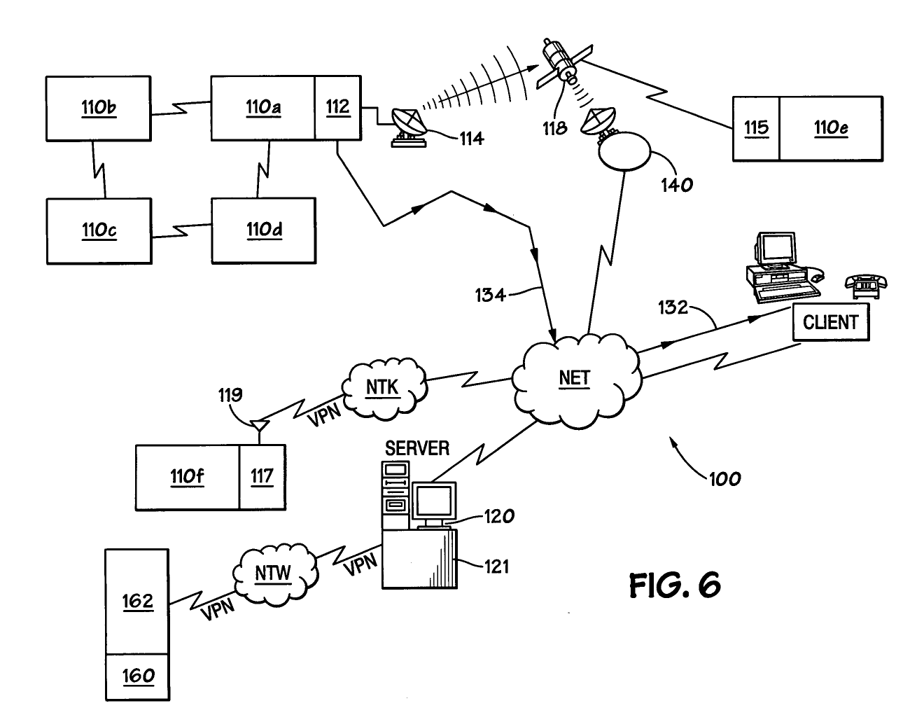

As shown in FIGS. 2A and 2B any system according to the present invention may have a ground radar unit 202 for viewing, identifying, and tracking objects, personnel, vehicles, and/or targets. As shown in FIG. 2A the system 202 may be mounted on a trailer enclosure 14d and as shown in FIG. 2B a system 202 may be mounted atop a mast 12. A system 202 can scan 360 degrees around a unit according to the present invention. A system 202 is in communication with a control system 64, and/or a central server (like the server 120, FIG. 6). Any suitable known radar system may be used; including, but not limited to, known perimeter surveillance radars.

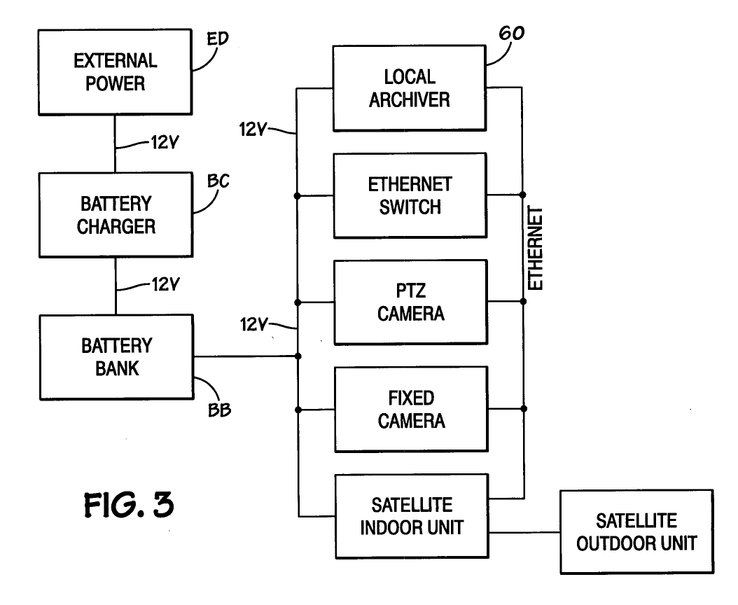

FIG. 3 illustrates one scheme for a surveillance unit 10 (e.g. as shown in FIGS. 1A, 1B). An external power source ED (e.g. a system 50) powers a battery BC which charges batteries in a battery bank BB (e.g. all at 12 volts). The battery bank BB provides electrical power (e.g. at 12 volts) to the local archiver 60 (and its various components and systems with voltage inversion as required); to an ethernet switch 77; to the PTZ camera 24; to indoor and outdoor satellite units; and to the fixed camera 20.

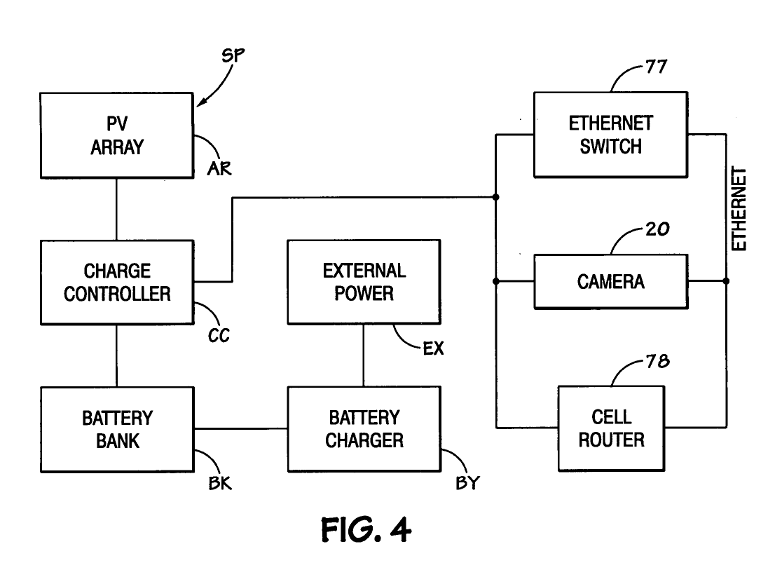

Optionally, as shown in FIG. 4, communication is provided to a surveillance unit according to the present invention via a satellite system SS which includes a satellite outdoor unit SO connected to a satellite unit SP. The local archiver 60, etc. are connected via standard computer networking protocol, e.g. an ethernet connection, “ETHERNET”.

FIG. 4 also illustrates a power scheme for a surveillance unit 10 which includes a solar power system SP with a photovoltaic array AR (“PV Array”). The solar power system SP provides power (e.g. at 24 volts) to a charge controller CC which charges batteries in a battery bank (all e.g. at 12 volts). Optionally, an external power system EX (e.g. a system 50) powers a battery charger BY (e.g. at 120 volts) which in turn charges batteries in the battery bank BB (e.g. at 12 volts). The charge controller CC provides power (e.g. at 12 volts) to the ethernet switch 77; the camera (e.g. a camera 20 or 24); the cellular router 78; and to the local archiver. “ETHERNET” between the three items in FIG. 4 indicates data communication, including video data.

FIG. 6 illustrates a system 100 according to the present invention which includes multiple surveillance units 110 according to the present invention (e.g. like any surveillance unit according to the present invention, e.g., but not limited to, the surveillance unit system 10 and 10a). The surveillance units 110 can be at different locations or sites and they can be separated by relatively large distances, e.g. many miles.

A central server 120 with an archiver 121 is in communication with all the surveillance units 100. A client whose sites, locations, and/or equipment is under surveillance via the surveillance units 110 communicates with the central server 120 via any known method or system of communication. As shown this communication is via a network (“NET”) which can be the internet or any private network. The central server can serve as a single unified platform at which the client can monitor and/or view multiple remote units according to the present invention using one piece of software on a single computer.

The line labelled 132 (“VIDEO FLOW”) indicates the transmission of video data from a unit to a client and provides the client real time access to streaming video from each video camera of each surveillance unit (and, in some aspects, access to archived video of each camera).

A local archiver 112 is in communication with its own surveillance unit 110a and via any suitable form of communication (wired or wireless) with several other surveillance unit systems 110a, 110b, and 110c. Via a satellite uplink system 114, the local archiver 112 is in communication with a satellite system 118 which in turn communicates with a teleport 140 (a main downlink/uplink hub for satellite communication). The teleport 140 conveys the information from the local archiver 112 to the NET network. This includes every type of information from every component, camera, sensor, detector, etc. of the surveillance units 110a-d. The teleport 140 is also in communication, via the satellite system 118, with a local archiver 115 of a surveillance unit 110a spaced-apart from the surveillance unit 110 with the local archiver 112. The surveillance unit 110c which may not be able to communicate with the local archiver 112 (e.g. due to distance, terrain, conditions), communicates with either unit 110b or 110d, each of which then communicates data from the unit 110c to the local archiver 112.

Line 134 indicates the transmission of video data from the archiver 112 to the NET network.

A cellular router 117 with an antenna 119 of a surveillance unit 110f communicates with the NET network. Optionally an intermediary network NTK is used.

The archiver 121 of the central server 120 communicates via a network NTW with a local archiver 160 of an office 162. For example, the office 162 is a field office at a construction site which may have multiple cameras, e.g. sixteen cameras (viewable at the office and/or at a remote location). The office 162 and the router 117 may communicate with the NET network via a virtual private network (“VPN”).

In one aspect of a method according to the present invention a remote user accesses a single camera of a unit according to the present invention over a cellular internet connection to view the camera. Multiple cameras could be added to this unit and accessed in the same manner whether the network connection is cellular, satellite, etc. In this mode, the trailer (or trailers) acts as an independent unit not joined in any particular network.

In another aspect of a method according to the present invention with a unit according to the present invention with a camera or multiple cameras that is part of a larger network of units, each unit communicates with a central server over cellular, satellite, etc. The server manages the connections between the units and remote viewers, and the central server archives video from each and/or every camera if desired. A user connects to the central server, and then accesses each unit and its associated cameras and sensors for viewing. If the central server is recording video data, then the user can view the recorded video. The communication between the units and central servers takes place over a Virtual Private Network, while the user connection to the server does not necessarily need to take place over a VPN.

In one aspect in a system and method according to the present invention a unit according to the present invention with a local archiver onboard records video for each of a plurality of cameras on the unit. The unit connects to a central server for user connections and management purposes. The user is able to access recorded video data from the unit's local archiver. The unit need not continuously stream video to the central server for recording purposes since recording is occurring locally on the local archiver. This system (and those like it according to the present invention) is not limited in bandwidth as are some remote communications methods which employ satellite or cellular limited bandwidth systems, and/or which are charged per bandwidth used. Using a local archiver according to the present invention allows for recording more camera video streams than could fit over a limited network connection. For example, with four cameras in a system according to the present invention with a bandwidth requirement of 128 kbit/sec each camera is connected to a local archiver that only has a single 128 kbit/sec satellite connection. Only one camera is remotely viewed live at a time, but all four are continuously recording locally. The unit-to-central-server connections, in one particular aspect, can take place over a VPN.

In one aspect of systems and methods according to the present invention multiple units are connected to a single main unit that contains a local archiver and a satellite or cellular connection. Every camera on every trailer in this small local network records its video to the main unit's local archiver. The local unit network may be a wireless mesh network, wired fiber optic network, etc.

For any system according to the present invention, a client can directly access a unit according to the present invention over a network connection, e.g. an internet connection. Alternatively, a client can access a central server, which acts as a proxy to the unit(s) according to the present invention.

It is within the scope of the present invention for any unit according to the present invention to have heater apparatus H (see FIG. 1B) and/or cooler apparatus C (see FIG. 1B) in or adjacent any part of the unit, including, but not limited to, in or adjacent the unit's main body (trailer enclosure, housing, etc.); in or adjacent a control system; in or adjacent a local archiver; and/or in or adjacent an electronics enclosure.

The present invention, therefore, provides in at least some embodiments, but not necessarily all embodiments, methods for surveilling a site, the methods including: locating a first unit for surveillance at a site, the first unit including a first base, a first local archiver, first surveillance apparatus on the base for surveilling the site with at least one first surveillance component; producing first surveillance signals with the first surveillance component; transmitting the first surveillance signals from the first surveillance component to the first local archiver; processing the first surveillance signals in the local archiver to produce a first record of the surveilling of the site; and making the first record available by remote access. Such methods may include one or some, in any possible combination, of the following: wherein the at least one first surveillance component includes a first video camera and the first record is a video record; wherein the at least one first surveillance component is at least one of, some or, or all of still camera, video camera, PTZ camera, and sensor; wherein the sensor is at least one of, some of, or all of motion sensor, gas sensor, temperature sensor, humidity sensor, electrical sensor (meter, gauge, instrument, voltmeter, ammeter), chemical agent sensor, and biological agent sensor; sending sensor signals from the sensor to the first local archiver, the sensor signals indicative of a parameter sensed by the sensor; remotely accessing the first local archiver, and reviewing the first record; wherein the remotely accessing is done wirelessly via one of network connection (e.g., private network and/or Internet) and/or satellite system; wherein the network connection is provided by one of an internet and a virtual private network; wherein the remotely accessing is done in communication with a central server in communication with the first local archiver; processing the first surveillance signals with the local archiver to produce a first viewable version of the first surveillance signals, remotely accessing the local archiver, and remotely viewing the first viewable version in real time; wherein the remotely accessing is done wirelessly via one of network connection and satellite system; locating a second unit for surveillance spaced-apart from the first unit, each of the first unit and the second unit having a mesh radio system, the second unit including a second base, a second surveillance apparatus for surveilling an area adjacent the second unit and including at least one second surveillance component, the second surveillance component for producing second surveillance signals, transmitting the second surveillance signals from the second unit to the first unit via the mesh radio systems, processing the second surveillance signals from the second surveillance apparatus in the first local archiver and/or in a second local archiver of the second unit to produce a second record of the surveillance of the area adjacent the second unit, and making the second record available by remote access; wherein the at least one second surveillance component includes a second video camera and second record is a video record; wherein the at least one second surveillance component is one of still camera, video camera, PTZ camera, and sensor; wherein the sensor is at least one of, some of, or all of motion sensor, gas sensor, electrical sensor, chemical agent sensor, and biological agent sensor; remotely accessing the first local archiver, and reviewing the second record; wherein the remotely accessing is done wirelessly via one of network connection and satellite system; processing the second surveillance signals with the first and/or second local archiver to produce a second viewable version which is a viewable version of the second surveillance signals, remotely accessing either or both archivers, and viewing the second viewable version in real time; wherein said remotely accessing is done in communication with a central server in communication with the first local archiver and/or the second local archiver; processing the second surveillance signals with the first local archiver to produce a second viewable version which is a viewable version of the second surveillance signals, remotely accessing the first local archiver, and viewing the second viewable version in real time; wherein the remotely accessing is done wirelessly via one of network connection and satellite system; wherein the network connection is provided by one of an internet and/or a virtual private network; and/or locating a second unit for surveillance spaced-apart from the first unit, the second unit including a second base, a second local archiver, a second surveillance apparatus for surveilling an area adjacent the second unit and including at least one second surveillance component, the second surveillance component for producing second surveillance signals, transmitting the second surveillance signals from the second unit to the second local archiver, processing the second surveillance signals from the second surveillance apparatus in the second local archiver to produce a second record of the surveillance of the area adjacent the second unit, and making the first record and the second record each available by remote by accessing a central server, the central server in communication with the first local archiver and with the second local archiver.

The present invention provide, therefore, in certain aspects, systems for surveilling a site, the systems including: a first unit for surveillance at a site, the first unit including a first base, a first local archiver, first surveillance apparatus on the base including at least one first surveillance component, the at least one first surveillance component for producing first surveillance signals, first transmitting apparatus for transmitting the first surveillance signals from the first surveillance component to the first local archiver, the local archiver processing apparatus for processing the first surveillance signals to produce a first record of the surveilling of the site, and the local archiver including connection apparatus for making the first record available by remote access. Such systems may have one or some, in any possible combination, of the following: wherein the at least one first surveillance component is one of still camera, video camera, PTZ camera, and sensor, wherein the sensor is one of motion sensor, gas sensor, temperature sensor, humidity sensor, electrical sensor, chemical agent sensor, and biological agent sensor, and apparatus for sending sensor signals from the sensor to the first local archiver, the sensor signals indicative of a parameter sensed by the sensor; a second unit for surveillance spaced-apart from the first unit, each of the first unit and the second unit having a mesh radio system, the second unit including a second base, a second surveillance apparatus for surveilling an area adjacent the second unit and including at least one second surveillance component, said second surveillance component for producing second surveillance signals, second transmitting apparatus for transmitting the second surveillance signals from the second unit to the first unit via the mesh radio systems, the first local archiver including processing apparatus for processing the second surveillance signals from the second surveillance apparatus in the first local archiver to produce a second record of the surveillance of the area adjacent the second unit, and the local archiver connection apparatus also for making the second record available by remote access; and/or the second unit including a second local archiver, and transmitting apparatus for transmitting the second surveillance signals from the second unit to the second local archiver, the second local archiver including processing apparatus for processing the second surveillance signals from the second surveillance apparatus to produce a second record of the surveillance of the area adjacent the second unit, and a central server in communication with the first local archiver and with the second local archiver so that the first record and the second record are each available by remote access via the central server.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventor may rely on the Doctrine of Equivalents to determine and assess the scope of the invention and of the claims that follow as they may pertain to apparatus not materially departing from, but outside of, the literal scope of the invention as set forth in the following claims. All patents and applications identified herein are incorporated fully herein for all purposes. It is the express intention of the applicant not to invoke 35 U.S.C. § 112, paragraph 6 for any limitations of any of the claims herein, except for those in which the claim expressly uses the words ‘means for’ together with an associated function. In this patent document, the word “comprising” is used in its non-limiting sense to mean that items following the word are including, but items not specifically mentioned are not excluded. A reference to an element by the indefinite article “a” does not exclude the possibility that more than one of the element is present, unless the context clearly requires that there be one and only one of the elements.

What is claimed is:

1. A method for surveilling a site, the method comprising
locating a first unit for surveillance at a site, the first unit including a first base, a first local archiver, and first surveillance apparatus on the base for surveilling the site with at least one first surveillance component,
producing first surveillance signals with the at least one first surveillance component,
transmitting the first surveillance signals from the at least one first surveillance component to the first local archiver,
processing the first surveillance signals in the local archiver to produce a first record of the surveilling of the site, and
making the first record available by remote access.

2. The method of claim 1 wherein the at least one first surveillance component includes a first video camera and the first record is a video record.

3. The method of claim 1 wherein the at least one first surveillance component is one of still camera, video camera, PTZ camera, and sensor.

4. The method of claim 3 wherein the sensor is one of motion sensor, gas sensor, temperature sensor, humidity sensor, electrical sensor, chemical agent sensor, and biological agent sensor.

5. The method of claim 3 further comprising
sending sensor signals from the sensor to the first local archiver, said sensor signals indicative of a parameter sensed by the sensor.

6. The method of claim 1 further comprising
remotely accessing the first local archiver, and
reviewing the first record.

7. The method of claim 6 wherein said remotely accessing is done wirelessly via one of or both network connection and satellite system.

8. The method of claim 7 wherein the network connection is provided by one of an internet and a virtual private network.

9. The method of claim 6 wherein said remotely accessing is done in communication with a central server in communication with the first local archiver.

10. The method of claim 1 further comprising
processing the first surveillance signals with the local archiver to produce a first viewable version of the first surveillance signals,
remotely accessing the local archiver, and
viewing the first viewable version in real time.

11. The method of claim 10 wherein said remotely accessing is done wirelessly via one of network connection and satellite system.

12. The method of claim 1 further comprising
locating a second unit for surveillance spaced-apart from the first unit, each of the first unit and the second unit having a mesh radio system,
the second unit including a second base, a second surveillance apparatus for surveilling an area adjacent the second unit and including at least one second surveillance component, said at least one second surveillance component for producing second surveillance signals,
transmitting the second surveillance signals from the second unit to the first unit via the mesh radio systems,
processing the second surveillance signals from the second surveillance apparatus in the first local archiver to produce a second record of the surveillance of the area adjacent the second unit, and
making the second record available by remote access.

13. The method of claim 12 wherein the at least one second surveillance component includes a second video camera and second record is a video record.

14. The method of claim 13 wherein the at least one second surveillance component is one of still camera, video camera, PTZ camera, and sensor.

15. The method of claim 13 wherein the sensor is one of motion sensor, gas sensor, electrical sensor, chemical agent sensor, and biological agent sensor.

16. The method of claim 12 further comprising
remotely accessing the first local archiver, and
reviewing the second record.

17. The method of claim 16 wherein said remotely accessing is done wirelessly via one of network connection and satellite system.

18. The method of claim 17 further comprising
processing the second surveillance signals with the first local archiver to produce a second viewable version which is a viewable version of the second surveillance signals,
remotely accessing the first local archiver, and
viewing the second viewable version in real time.

19. The method of claim 18 wherein said remotely accessing is done in communication with a central server in communication with the first local archiver.

20. The method of claim 12 wherein the second surveillance unit includes a second local archiver, and the method further comprising
processing the second surveillance signals with the second local archiver to produce a second viewable version which is a viewable version of the second surveillance signals,
remotely accessing the second local archiver, and
viewing the second viewable version in real time.

21. The method of claim 18 wherein said remotely accessing is done wirelessly via one of network connection and satellite system.

22. The method of claim 21 wherein the network connection is provided by one of an internet and a virtual private network.

23. A method for surveilling a site, the method comprising
locating a first unit for surveillance at a site, the first unit including a first base, a first local archiver, and first surveillance apparatus on the base for surveilling the site with at least one first surveillance component,
producing first surveillance signals with the at least one first surveillance component,
transmitting the first surveillance signals from the at least one first surveillance component to the first local archiver,
processing the first surveillance signals in the local archiver to produce a first record of the surveilling of the site,
making the first record available by remote access,
locating a second unit for surveillance spaced-apart from the first unit,
the second unit including a second base, a second local archiver, a second surveillance apparatus for surveilling an area adjacent the second unit and including at least one second surveillance component, said at least one second surveillance component for producing second surveillance signals,
transmitting the second surveillance signals from the second unit to the second local archiver,
processing the second surveillance signals from the second surveillance apparatus in the second local archiver to produce a second record of the surveillance of the area adjacent the second unit, and
making the first record and the second record each available by remotely accessing a central server, the central server in communication with the first local archiver and with the second local archiver.

24. A system for surveilling a site, the system comprising
a first unit for surveillance at a site, the first unit including
a first base,
a first local archiver,
first surveillance apparatus on the base including at least one first surveillance component,
the at least one first surveillance component for producing first surveillance signals,
first transmitting apparatus for transmitting the first surveillance signals from the at least one first surveillance component to the first local archiver,
the local archiver processing apparatus for processing the first surveillance signals to produce a first record of the surveilling of the site, and
the local archiver including connection apparatus for making the first record available by remote access.

25. The system of claim 24
wherein the at least one first surveillance component is one of still camera, video camera, PTZ camera, and sensor,
wherein the sensor is at least one of motion sensor, gas sensor, temperature sensor, humidity sensor, electrical sensor, chemical agent sensor, and biological agent sensor, and
the first local archiver includes apparatus for sending sensor signals from the sensor to the first local archiver, said sensor signals indicative of a parameter sensed by the sensor.

26. The system of claim 24 further comprising
a second unit for surveillance spaced-apart from the first unit,
each of the first unit and the second unit having a mesh radio system,
the second unit including a second base, a second surveillance apparatus for surveilling an area adjacent the second unit and including at least one second surveillance component, said at least one second surveillance component for producing second surveillance signals,
second transmitting apparatus for transmitting the second surveillance signals from the second unit to the first unit via the mesh radio systems,
the first local archiver including processing apparatus for processing the second surveillance signals from the second surveillance apparatus in the first local archiver to produce a second record of the surveillance of the area adjacent the second unit, and
the first local archiver connection apparatus also for making the second record available by remote access.

27. The system of claim 26 further comprising
the second unit including a second local archiver, and transmitting apparatus for transmitting the second surveillance signals from the second unit to the second local archiver,
the second local archiver including processing apparatus for processing the second surveillance signals from the second surveillance apparatus to produce a second record of the surveillance of the area adjacent the second unit, and
a central server in communication with the first local archiver and with the second local archiver so that the first record and the second record are each available by remote access via the central server.
